(19) United States
(12) Patent Application Publication
(10) Pub. No.: US 2015/0360192 A1
(43) Pub. Date: Dec. 17, 2015

(54) GELLED CAPSULES, AND REINFORCED LYOPHILISED GELLED CAPSULES, CONTAINING NANO - OBJECTS, AND PROCESSES FOR PREPARING SAME

(71) Applicant: COMMISSARIAT À L'ÉNERGIT ATOMIQUE ET AUX ÉNERGIES ALTERNATIVES, Paris (FR)

(72) Inventors: Pascal TIQUET, Grenoble (FR); Lionel FILHOL, Saint-Sauveur (FR); Jean-Francois GUILLET, Toulouse (FR)

(73) Assignee: COMMISSARIAT A L'ENERGIE ATOMIQUE ET AUX ENERGIES ALTERNATIVES, Paris (FR)

(21) Appl. No.: 14/761,880

(22) PCT Filed: Jan. 16, 2014
(86) PCT No.: PCT/EP2014/050825

§ 371 Date: Jul. 17, 2015

(30) Foreign Application Priority Data
Jan. 18, 2013 (FR) 1350454

(51) Int. Cl. B01J 13/22; C08K 9/10; B01J 13/20

(52) U.S. Cl. CPC B01J 13/22; B01J 13/206; C08K 9/10

(57) ABSTRACT

A reinforced gelled capsule comprising a solvent, in which are distributed in a homogeneous manner nano-objects, and/or sub-micron objects, and/or nanostructures, coated with macromolecules of polysaccharide(s), the said macromolecules forming, in at least one part of the capsule, a gel by cross-linking with the cations of at least one element, and in which the external surface of the capsule is covered with crystals made of hydroxide of said element.

A method for preparing the reinforced, gelled capsule.

A reinforced, lyophilised, gelled capsule, prepared by means of lyophilisation, then followed by exposure to a gas containing carbon dioxide, of the said reinforced, gelled capsule and method of preparation thereof.

### TECHNICAL FIELD

The present invention relates to reinforced gelled capsules containing nano-objects.

More precisely, the present invention relates to reinforced gelled capsules containing nano-objects such as carbon nanotubes or silicon nanoparticles and/or sub-micron objects and/or nanostructures.

The present invention also relates to reinforced lyophilised gelled capsules manufactured by freeze-drying (lyophilisation) of said gelled capsules.

The term “reinforced”, is used to refer to capsules that are less fragile than existing known capsules.

Furthermore the present invention also relates to nanocomposite materials having a polymer matrix comprising these reinforced gelled capsules, or these gelled capsules, which are lyophilized, and reinforced or prepared based on these gelled capsules.

The invention also relates to a method for preparing these capsules and a method for preparing these nanocomposite materials having a polymer matrix based on these capsules.

Finally, the invention relates to the use of these capsules.

### STATE OF THE ART

The technical field of the invention may, in a general manner, be considered to be that of the inclusion, the incorporation, and the confinement, for various purposes, of nano-objects such as nanoparticles or sub-micron objects in materials such as polymers.

Thus, in accordance with a first aspect of the invention, the technical domain of the invention may be more precisely defined as that of the protection and the confinement of nanoparticles and nano-objects with a view to their manipulation.

It should also be noted that the invisible nature of these nano-objects due to their small size, and the lack of knowledge of their potential impact on the biological environment and the universe of living organisms also necessitate confinement and encapsulation in order to control their diffusion and to satisfy the principle of precaution.

The technical field of the invention may be defined more precisely in accordance with another aspect, as that of composite materials, or more precisely that of nanocomposite materials and, in particular, of nanocomposite materials having a polymer matrix.

Nanocomposite materials having a polymer matrix are multi-phase materials, in particular bi-phase materials, which include a polymer matrix forming a first phase in which are dispersed nano-objects such as nanoparticles that make up at least a second phase that is generally known as the reinforcement or charge (loading) phase.

Nanocomposites are so named because at least one of the dimensions of the objects, such as the particles making up the reinforcement or charge phase, is on a nanometric scale, that is to say usually less than or equal to 100 nm, for example in the order of 1 nanometre to one or a few tens of nanometres, notably from 1 to 100 nm. As a consequence, these objects and particles are known as nano-objects or nanoparticles.

The document FR-A1-2934600 describes agglomerates or capsules comprising a solvent, in which are dispersed in a homogeneous manner nano-objects or nanostructures coated with macromolecules of polysaccharide, these macromolecules making up, at least in one part of the agglomerate, a gel by cross-linking (reticulation) with positive ions.

The document WO-A1-2010/012813 describes lyophilised, gelled capsules or agglomerates, that are prepared by means of lyophilisation of the gelled capsules or agglomerates described in the document FR-A1-2934600.

It is indicated in these documents that the capsules described therein make it possible to prepare, in particular, nanocomposite materials having a polymer matrix in which the nano-objects or nanostructures are dispersed, distributed, and organised in a homogeneous manner, in particular at low concentrations.

These capsules may also be used to serve as chemical microreactors.

According to these documents, these capsules also ensure the confinement of the nano-objects and make it possible to control their diffusion in the environment.

It can be considered that the capsules described in the document FR-A1-2934600 comprise an external membrane made of polysaccharide, for example made of alginate, which envelops the capsule and confines the nano-objects or nanostructures.

However, this membrane which is made up essentially of macromolecules of polysaccharide, for example stacked macromolecules of alginate, proves to be fragile during lyophilisation.

In FIG. 1, one can see clearly the tearing that occurs in the external membrane of the gelled capsules at the time of the lyophilisation of these capsules, according to the process described in the document WO-A1-2010/012813.

In the same way, the external membrane of the lyophilised capsules described in the document WO-A1-2010/012813 can tear as shown in FIG. 2.

In this figure, it is possible to observe the torn zones of the external membrane of a lyophilised capsule prepared according to the process described in the document WO-A1-2010/012813.

The fragility of both the gelled capsules described in the document FR-A1-2934600 as well as the gelled, lyophilised capsules described in the document WO-A1-2010/012813 thus poses extremely significant problems with regard to “nano security”, in effect the capsules no longer serve the function of confinement, and the nano-objects and the nanostructures and all the contents of the capsules thus escape and are disseminated into the environment.

In addition, as in the case of the capsule shown in FIG. 2, the lyophilised capsules may be used as microreactors, for example as a microreactor for the technique of chemical vapour phase deposit (CVD) (see the document FR-A-2981643), and the membrane should then, in principle, ensure the confinement of the reagents within the interior of the capsule.

The tearing of the membrane shown in FIG. 2 leads to a rupture of the confinement and allows the reagents and the products of the reaction to escape, thus contributing to reducing the efficiency of the reaction. The problems caused by loss of efficiency thus get added to those linked to the problem of dissemination.

There is therefore a need, in view of the above, to make the capsules prepared as described in the documents FR-A1-2934600 and WO-A1-2010/012813 less fragile, so as to increase their mechanical resistance, in order for their function of confinement to be ensured, and in order for their contents, that is in particular the nano-objects and nanostructures, to not be scattered, and disseminated in the environment, even when the capsules are subjected to strains.

There is also a need, when these capsules are used as microreactors, to prevent the reagents and reaction products from escaping from the capsules, thus causing a loss of the reaction efficiency.

The goal of the present invention is inter alia to meet this need.

The goal of the present invention is also to provide for capsules which do not have the drawbacks, defects, limitations and disadvantages of those capsules prepared as described in the documents FR-A1-2934600 and WO-A1-2010/012813, and which solve the problems encountered with the capsules described in these documents.

### PRESENTATION OF THE INVENTION

This aim, and others are achieved, in accordance with a first aspect of the invention, by the provision of a reinforced gelled capsule comprising a solvent, in which are distributed in a homogeneous manner nano-objects, and/or sub-micron objects, and/or nanostructures, coated with macromolecules of polysaccharide(s), the said macromolecules forming, in at least a part of the capsule, a gel by cross-linking with the cations of at least one element, and wherein the external surface of the capsule is covered with crystals made of hydroxide of said element.

Each macromolecule consists of a single polysaccharide, and a single polysaccharide or a plurality of polysaccharides may be used.

The reinforced gelled capsule, according to the invention, differs fundamentally from the gelled capsules of document FR-A1-2934600 in that its external surface is covered with hydroxide crystals, which are generally present in the form of discrete island like blocks.

In other words, in the gelled capsule, reinforced according to the invention, a shell of hydroxide is built, for example of calcium hydroxide, which is generally discontinuous in thickness, and in the form of sheets (strata) in the plane, around the gelled capsules of document FR-A1-2934600.

The exterior of the gelled capsule is generally composed uniquely of one layer of polysaccharide(s), such as an alginate, which is cross-linked, organised in sheets, with for example the number of sheets being from 10 to 100. Each sheet may have for example a thickness of from 1 to 10 nm, which may make for a total thickness of from 100 nm to 1 μm, in particular 100 nm. The external surface of this layer of cross-linked polysaccharide(s) constitutes the external surface of the gelled capsule.

In this way, thanks to these hydroxide crystals, the reinforced gelled capsule according to the invention has a greater mechanical resistance and is far less fragile than the gelled capsules of document FR-A1-2934600. This is why this capsule is referred to as “reinforced”.

The reinforced gelled capsule according to the invention fulfills its function of confining nano-objects, sub-micron objects, nanostructures, reagents and reaction products with a far greater level of security and safety than the capsules of document FR-A1-2934600.

For simplification, this capsule may be named as “gelled agglomerate”, or “gelled capsule”, or even “first capsule”, or “first agglomerate”. Because the external surface of the capsule is covered with hydroxide crystals, this capsule is referred to as a “reinforced gelled capsule”.

The layer, or shell, of hydroxide generally has a thickness of from 10 μm to 500 μm.

The terms “capsule” and “agglomerate” are used interchangeably with the same meaning in the present document.

The term “distributed in a homogeneous manner”, is generally used to indicate that the nano-objects and/or sub-micron objects, and/or nanostructures are uniformly or regularly distributed in the capsule and that their concentration is substantially the same throughout the entire capsule, in all of the parts thereof.

The gel may be formed throughout the whole of (in all) the capsule, or else the gel may be formed only in one part of the capsule, for example only at the surface of the capsule, the interior of the capsule being in the liquid state. Preferably however, the gel is formed throughout the whole of the capsule, in other words the capsule is gelled “to the core”.

Advantageously, the concentration of nano-objects and/or of sub-micron objects and/or nanostructures (which is greater than 0% by mass) is less than or equal to 5% by mass, preferably it is less than or equal to 1% by mass, more preferably it is from 10 ppm to 0.1% by mass of the total mass of the capsule.

The solvent of the capsule may comprise 50% or more by volume of water, preferably 70% or more of water, more preferably 99% or more of water, or even better 100% of water (the solvent of the capsule is then entirely constituted of water).

The solvent of the capsule, when it does not comprise 100% of water, may further comprise at least one other solvent compound, generally chosen from amongst alcohols and, in particular, the aliphatic alcohols, such as ethanol; or the polar solvents, in particular, ketones such as acetone; and the mixtures thereof.

The nano-objects may be chosen from amongst nanotubes, nanowires, nanofibres, nanoparticles, nanocrystals, and the mixtures thereof; and the sub-micron objects may be chosen from the sub-micron particles.

The materials constituting the nano-objects, nanostructures, or sub-micron objects may be chosen from amongst carbon; sulphur; metals such as tin; metal alloys; metalloids such as silicon; metalloid alloys; metal oxides such as rare earth oxides optionally doped; metalloid oxides; ceramics; organic polymers; and materials comprising several of the above materials.

The nano-objects and/or sub-micron objects, and/or nanostructures may comprise carbon nano-objects; and optionally nano-objects or sub-micron objects made of at least one material other than carbon (non-carbon material) such as silicon.

Advantageously, the carbon nano-objects are chosen from amongst carbon nanotubes (“CNT”), carbon nanowires, carbon nanofibers, carbon nanoparticles, carbon nanocrystals, carbon blacks, and the mixtures thereof; and the nano-objects or sub-micron objects made of at least one material other than carbon are chosen from amongst nanotubes, nanowires, nanofibres, nanoparticles, sub-micron particles, nanocrystals, made of at least one material other than carbon such as silicon, and the mixtures thereof. The materials other than carbon may be chosen from amongst the materials other than carbon cited here above.

The carbon nanotubes may be chosen from single-walled carbon nanotubes (“SWCNT”) and multi-walled carbon nanotubes (“MWCNT”) such as double-walled carbon nanotubes.

The macromolecules of polysaccharide(s) may be chosen from amongst pectins, alginates, alginic acid and carragheenans.

The alginates may be alginates extracted from the brown algae Phaeophyceae, mainly the Laminaria such as Laminaria hyperborea; and the Macrocystis such as Macrocystis pyrifera.

Advantageously, the polysaccharide macromolecule has a molecular mass of from 80000 g/mol to 500000 g/mol, preferably from 80000 g/mol to 450000 g/mol.

The gelled capsule or agglomerate, particularly in the event where it does not already also comprise a polymer that is soluble in the solvent of the first capsule, may be impregnated with at least one polymer or monomer that is soluble in the solvent of the capsule, preferably with a water-soluble polymer chosen, for example, from amongst the polyethylene glycols (PEG), the poly(ethylene oxides), the poly(acrylamides), the poly(vinyl pyridines), the (meth)acrylic polymers, the chitosans, the celluloses, the PVAs (polyvinyl alcohols), and all the other water-soluble polymers.

The gelled capsule may in addition be cross-linked and/or polymerized.

Advantageously, said element is calcium, and the hydroxide is calcium hydroxide Ca(OH)₂.

In general, the reinforced, gelled capsule according to the invention is spherical or is spheroidal.

Advantageously, the reinforced, gelled capsule according to the invention has a size that is defined by its largest dimension, such as the diameter in the case of a spherical or spheroidal capsule of 100 μm to 2 mm, preferably of 500 μm to 1 mm.

The invention also relates to a reinforced, lyophilised, gelled capsule, prepared by lyophilisation, then by exposure to a gas containing carbon dioxide, of the reinforced, gelled capsule, described here above, in which the external surface of the capsule is covered with a layer of carbonate of said element.

During the exposure to a gas containing carbon dioxide, such as air, the hydroxide is transformed into a carbonate.

The capsule prepared by means of lyophilisation of the gel capsule or first capsule may be referred to as “lyophilised, gelled capsule” or, more simply, “lyophilised capsule”.

Due to the fact that the external surface of the capsule is covered with a layer or shell of hardened carbonate, this capsule is referred to as “reinforced, lyophilised, gelled capsule”.

In the event where the element is calcium, the layer or shell is a layer or shell of calcium carbonate.

The reinforced, lyophilised, gelled capsule according to the invention is fundamentally differentiated from the lyophilised, gelled capsules of document WO-A1-2010/012813 in that its external surface is covered by a layer or shell of carbonate, for example of calcium carbonate, CaCO₃.

In other words, in the reinforced, lyophilised, gelled capsule according to the invention, a layer or shell of carbonate, for example of calcium carbonate is produced around the lyophilised, gelled capsules of document WO-A1-2010/012813.

In this way, because of this carbonate shell, the reinforced, lyophilised, gelled capsule according to the invention has a greater mechanical resistance, and is far less fragile than the lyophilised, gelled capsules of document WO-A1-2010/012813; this is the reason why the capsule is said to be “reinforced”.

The reinforced, lyophilised, gelled capsule according to the invention fulfills its function of confining nano-objects, sub-micron objects, nanostructures, reagents and reaction products with a far greater level of security and safety than the capsules of document WO-A1-2010/012813.

The layer, shell of carbonate is generally organised in sheets (strata).

The layer, shell of carbonate is compact (at the level of the sheets), porous (between the sheets), discontinuous (on account of the succession of sheets), and resistant, and has a thickness generally of 10 μm to 500 μm.

This layer of carbonate makes it possible, when the reinforced, lyophilised, gelled capsules according to the invention are used as microreactors, to confine the reagents and the reaction products, to contain the pressure of the vaporised compounds, and to limit the diffusion of the reagents and of the reaction products.

The homogeneous distribution of the nano-objects and/or sub-micron objects, and/or nanostructures is in addition maintained in the lyophilised capsule prepared from the first capsule.

The term “lyophilisation” is term that is well known to the man skilled in the art. Lyophilisation generally includes a step of freezing during the course of which the solvent (liquid), for example the water of the first capsule, is put into a solid form, for example in the form of ice, and then a step of sublimation during the course of which, under the effect of a vacuum, the solid solvent, such as ice, is transformed directly into a vapour, for example water vapour, which is recovered. Optionally, when all the liquid solvent, for example all the ice, has been eliminated, the capsules are cold-dried.

During lyophilisation, the solvent of the first capsule will be totally eliminated, replaced by the polymer or monomer, preferably water-soluble such as PEG, that impregnates the gelled agglomerate.

In the same way, during lyophilisation, the solvent of the first capsule, or gelled capsule, may be totally eliminated and replaced by the polymer or monomer that is soluble in the solvent of the capsule and already present in the capsule.

The lyophilised capsule according to the invention generally contains from 1% to 90% by mass, preferably from 30% to 75% by mass, and more preferably from 50% to 60% by mass, of nano-objects and/or sub-micron objects, and/or nanostructures, and from 10% to 99% by mass, preferably from 25% to 70% by mass, and more preferably from 40% to 50% by mass of polysaccharide(s).

Advantageously, the lyophilised capsule according to the invention may in addition also have undergone, after lyophilisation, a heat treatment or an enzyme attack, treatment.

This enzyme attack may be carried out for example, using an enzyme for degradation of alginates, such as an enzyme of the type Alginate Lyase, for example enzyme EC 4.2.2.3, also known as E-poly(β-D-mannuronate)lyase.

The heat treatment or the enzyme treatment makes it possible to eliminate, at least in part, that is to say, partially or wholly, the polysaccharide(s) of the capsule that has undergone lyophilisation.

In general, the heat treatment makes it possible to eliminate, at least in part, the polysaccharide(s), whereas the enzyme treatment makes it possible generally to totally eliminate the polysaccharide.

The enzyme attack may be carried out in accordance with standard conditions within reach of the man skilled in the art, for example by putting the lyophilised capsules into an aqueous solution and introducting the enzyme into this solution.

After this heat or enzyme treatment, the lyophilised capsule generally contains from 50% to 100% by mass, or preferably from 80% to 100% by mass of nano-objects and/or sub-micron objects, and/or nanostructures.

This heat or enzyme treatment thus makes it possible to increase the content of nano-objects and/or sub-micron objects, and/or nanostructures, such as carbon nanotubes, without the structure of the agglomerates, or capsules being modified and without the homogeneous distribution of the nano-objects and/or sub-micron objects, and/or nanostructures in the capsule being affected.

The additional step of heat treatment, which could also be called the step of calcination of the lyophilised agglomerates or capsules, or the additional enzyme treatment step, in effect makes it possible to eliminate, at least partially, the polysaccharide(s), for example the alginate, while maintaining the organisation obtained previously and, in particular, the homogeneous distribution of the nano-objects and/or sub-micron objects, and/or nanostructures present in the first (gelled) capsules and in the lyophilised capsules.

The additional heat treatment or enzyme treatment step, carried out after the lyophilisation, thus makes it possible to create agglomerates or capsules loaded with nano-objects and/or sub-micron objects, and/or nanostructures, in particular in an amount from 80% to 95% by mass of the agglomerate.

Such a high amount is achieved even with a very low amount of nano-objects, and/or sub-micron objects, and/or nanostructures such as CNTs in the gelled capsules, because the tubes, for example, are generally long, having a length for example, comprised between 1 μml and 100 μm.

Such an amount is higher than all the amounts of nano-objects and/or sub-micron objects, and/or nanostructures obtained heretofore in such types of agglomerates or capsules, and this without the homogeneous distribution of thesenano-objects and/or sub-micron objects, and/or nanostructures and their three-dimensional organisation, already present both in the first gelled capsules and in the lyophilised capsules being affected in the capsules after heat treatment that could also be referred to as “calcinated” capsules, or in the capsules after enzyme treatment.

In other words, the step of heat treatment or calcination, or the step of enzyme treatment, aims to eliminate, totally or partially, the polysaccharide(s) in the lyophilised capsule. At the end of the step of heat treatment, calcination, or enzyme treatment, carried out after the lyophilisation, the structures obtained are structures that may be made up uniquely of nano-objects and/or sub-micron objects, and/or nanostructures (when the polysaccharide such as alginate has been totally removed) such as CNTs, these structures being organised and porous, which is an advantage for integrating these structures into certain polymers.

The content or concentration of polysaccharide in the capsules after heat or enzyme treatment is generally from 1% to 50% by mass, preferably from 1% to 20% by mass, or even 0% by mass, especially when an enzyme attack, treatment, is carried out.

Advantageously, the reinforced, lyophilised, gelled capsule according to the invention has a size that is defined by its largest dimension, such as the diameter in the case of a spherical or spheroidal capsule of between 100 μm and 2 mm, preferably from 500 μm to 1 mm.

The invention also relates to a solid nanocomposite material having a composite or polymer matrix, comprising a reinforced gelled capsule, or a reinforced, lyophilised, gelled capsule, according to the invention as described here above, in which the nano-objects and/or sub-micron objects, and/or nanostructures are distributed in a homogeneous manner.

The polymer(s) of the matrix may be chosen from amongst the aliphatic and apolar polymers like the polyolefins, such as the polyethylenes and polypropylenes; the polystyrenes; the copolymers of cycloolefins; but also from amongst the polar polymers such as the polyamides and poly(meth)acrylates such as PMMA [Poly(methyl methacrylate)]; and the mixtures thereof.

The polymer of the matrix may also be chosen from the polymers which melt or are soluble in water.

The composite of the matrix may be chosen from amongst these composite materials containing at least one polymer chosen for example from the polymers mentioned above for the matrix, and an inorganic filler.

The invention also relates to a method for preparing the reinforced, gel capsule, as defined here above, in which the following steps are carried out:

a) the nano-objects, and/or the nanostructures and/or the sub-micron objects are dispersed in a first solvent comprising a majority of water, and into the first solvent are put into solution, macromolecules of polysaccharide(s) and optionally, a polymer that is soluble or a salt that is soluble in the first solvent, whereby a first solution is obtained;

b) A third solution is prepared by bringing into contact the first solution with a second solution in a second solvent, comprising a majority of water, at least one salt, of least one element soluble in water, which is capable, of releasing into the second solution, cations of said element, the concentration of said element in the second solution being such that it is higher than the concentration of said element which corresponds to the solubility limit of the hydroxide of said element in said second solution whereby a gelled capsule is obtained;

c) The gelled capsule is separated from the third solution and it is rinsed with deionised water;

d) The gel capsule is immersed in a solution of an hydroxide of said element, the concentration of hydroxide of said element in said hydroxide solution being higher than the solubility limit of said hydroxide, and the concentration of the element within the interior of the capsule being higher than the concentration of the element in the hydroxide solution, whereby the reinforced, gelled capsule is obtained wherein the external surface of the capsule is covered with crystals of hydroxide of said element;

e) The reinforced, gelled capsule is removed from the hydroxide solution.

The first solvent may comprise 50% or more by volume of water, preferably 70% or more by volume of water, or more preferably 99% or more by volume of water, still better 100% by volume of water.

Advantageously, the nano-objects, nanostructures, and sub-micron objects, and the polysaccharides are as have already been defined here above.

The first solvent when it does not comprise 100% water, may also comprise at least one other solvent compound chosen generally from the alcohols, in particular the aliphatic alcohols such as ethanol; polar solvent compounds, in particular ketones such as acetone; or the mixtures thereof.

The dispersion of the nano-objects, and/or nanostructures, and/or sub-micron objects, in the first solvent and the putting into solution of the macromolecules of polysaccharide(s) may be two simultaneous operations, or they may indeed be two consecutive operations, the dispersion preceding the putting into solution, or vice versa.

Advantageously, the ratio of the number of macromolecules to the number of nano-objects and/or sub-micron objects, and/or nanostructures in the first solution may be from 1 to 10, preferably this ratio is equal to, or close to, 1.

The content of nano-objects and/or sub-micron objects, and/or nanostructures, and the content of macromolecules of polysaccharide(s) (which are higher than 0% by mass) may advantageously be less than or equal to 5% by mass, preferably less than or equal to 1% by mass, and even more preferably from 10 ppm to 0.1% by mass of the mass of the first solvent.

The second solvent may contain 50% or more by volume of water, preferably 70% or more by volume of water, more preferably 99% or more by volume of water, and still better 100% by volume of water.

The second solvent, when it does not comprise 100% of water, may further comprise at least one other solvent compound chosen generally from the alcohols, in particular the aliphatic alcohols such as ethanol; polar solvent compounds, in particular ketones such as acetone; and the mixtures thereof.

Advantageously, the second solvent is identical to the first solvent and preferably consists of water.

Advantageously, the cations are chosen from the monovalent cations, the divalent cations and the trivalent cations. Preferably, the divalent cations are chosen from Cd²⁺, Cu²⁺, Ca²⁺, Co²⁺, Mn²⁺, Fe²⁺, Hg²⁺; the monovalent cations are chosen from Li⁺, Na⁺, K⁺, Rb⁺, Cs⁺, Ag⁺, Ti⁺, Au⁺; and the trivalent cations are chosen from Fe³⁺, and Al³⁺; more preferably, the cations are Ca²⁺ cations.

Advantageously, the second solution may comprise several of salts, in such a manner that a mixture of cations, preferably a mixture of cations containing at least one monovalent cation, at least one divalent cation, and at least one trivalent cation can be released in the second solution.

Preferably, the second solution comprises only one salt which is a calcium salt, the hydroxide is calcium hydroxide.

The method for preparing the gelled capsule is reversible and may possibly also include in addition a step c1) (carried out on the capsule obtained at the end of the step c, during which the first capsule is placed in contact with at least one chelating agent such as diethylene tetramine pentaacetic acid (DTPA), ethylene diamine tetraacetic acid, or trientine (Triethylenetetramine, TETA) in order to trap and deactivate the role of the cations.

At the end of the step b) or step c), the capsule obtained, and optionally separated out for example by simple filtration, may also be impregnated by a solution of a polymer or monomer soluble in the first solvent, preferably by an aqueous solution of at least one water-soluble polymer or monomer chosen, for example, from amongst the polyethylene glycols (PEG), the polyethylene oxides), the poly(acrylamides), the poly(vinyl pyridines), the (meth)acrylic polymers, the chitosans, the celluloses, the PVAs (polyvinyl alcohols), and all the other water-soluble polymers.

However, as already mentioned, a polymer or monomer may also be added during the step a) so as to mechanically consolidate the solution of nano-objects dispersed due to the polysaccharide, the said polymer or monomer then being soluble in the solvent (“first solvent”) used in the step a). In particular, it could be a water-soluble monomer or polymer which may be chosen from the polymers already mentioned above.

The invention also relates to a method for preparing the reinforced, lyophilised, gelled capsule as defined above, in which a reinforced, gelled capsule is prepared by the method described here above, said reinforced, gelled capsule is lyophilised, and then said reinforced, gelled capsule is exposed to a gas containing carbon dioxide, whereby the crystals made of an hydroxide of said element that cover the external surface of the capsule are transformed into a layer of carbonate of said element.

The lyophilisation may be carried out on the first capsule, whether or not it comprises a polymer or a monomer added during the step a) and whether or not it has been impregnated by a solution of a polymer or a monomer, for example by an aqueous solution of a water-soluble polymer or monomer at the end of the step b) or the step c).

Following the lyophilisation, and after the exposure to a gas containing carbon dioxide, a heat treatment or enzyme treatment of the lyophilised, gelled agglomerate may optionally be carried out.

The goal of the heat or enzyme treatment is to eliminate, at least partially, the polysaccharide(s) still present.

Generally, by means of this heat treatment at least 30% by mass of the polysaccharide present in the lyophilised capsules may be eliminated, for example from 30% to 45% by mass. With an enzyme treatment, attack, it is even possible to totally eliminate the polysaccharide(s).

At the end of this heat or enzyme treatment, a capsule is obtained that generally comprises from 0% to 50% by mass, preferably from 0% to 20% by mass of polysaccharide, and from 50% to 100% by mass, preferably from 80% to 100% by mass of nano-objects, and/or nanostructures, and/or sub-micron objects.

The heat treatment must be carried out at a high enough temperature so as to eliminate, at least partially, the polysaccharide(s) from the lyophilised capsules.

Advantageously, it is carried out at a temperature of 400° C. to 600° C., preferably from 500° C. to 550° C., for a period of 1 hour to 5 hours, preferably from 1 hour to 3 hours, more preferably from 1 hour to 2 hours, for example at a temperature of 300° C. for a period of one hour.

The conditions for the enzyme treatment, as has already been indicated above, can easily be determined by the man skilled in the art.

Finally, the invention relates to a method for preparing a nanocomposite material in which the incorporation of at least one reinforced, lyophilised, gelled capsule, optionally heat or enzyme treated, or of at least one reinforced, gelled capsule, as defined above, in a polymer or composite matrix.

In other words, it is possible to incorporate in the polymer or composite matrix a reinforced, gelled capsule, or a reinforced, lyophilised, gelled capsule, or a heat treated, calcinated capsule, or an enzyme treated capsule.

The polymer of the matrix has already been defined above.

The incorporation of at least one reinforced, lyophilised, gelled capsule, optionally heat treated or enzyme treated, or of at least one reinforced, gelled capsule in the polymer matrix may be achieved by a plasturgy process such as extrusion.

The extrusion process involves bringing about melting of n-materials and kneading them along a screw or a twin-screw with a temperature profile and a speed of rotation optimised in order to obtain an optimal mix.

Located at the end of this screw or twin-screw, there is a die which shapes the mixture before it undergoes complete solidification. The shape may be like a bead or rush, a film or may have any sort of profile.

The capsules according to the invention make it possible to maintain, in the final, solid nanocomposite material according to the invention, the same organisation, in particular the same homogeneous distribution of the nano-objects, and/or of the nanostructures, and/or of the sub-micron objects as that which existed in the dispersion of these nano-objects, and/or nanostructures, and/or sub-micron objects in a liquid medium.

According to the invention, this organisation is maintained in the first reinforced, gelled capsule, then in the reinforced, lyophilised, gelled capsule, and in the capsule that has undergone heat or enzyme treatment.

In fact, the gelled structure of the capsules according to the invention makes it possible to fix, to set, or to “freeze” in a stable manner the organisation of these nano-objects, and/or nanostructures, and/or sub-micron objects, for example the homogeneous distribution which was that of the nano-objects, and/or nanostructures, and/or sub-micron objects in the liquid dispersion and to subsequently maintain it entirely in the final composite material.

Thanks to the capsules according to the invention, it is possible to maintain the state of dispersion of the nano-objects, and/or nanostructures, and/or sub-micron objects which existed in the initial dispersion, in the final nanocomposite material, which can then be treated or transformed in a conventional fashion by any plasturgy process, by extrusion for example.

In the final composite material, it is therefore found, for example, that the same homogeneous distribution of nano-objects, and/or nanostructures, and/or sub-micron objects is present throughout the whole of the volume of the material as in the initial dispersion.

The nanocomposite materials according to the invention are intrinsically differentiated from the existing nanocomposite materials previously described in the prior art, in particular in that they comprise the reinforced, gelled capsules or the reinforced, lyophilised, gelled capsules according to the invention, which convey to them intrinsically novel and unexpected properties compared with nanocomposite materials previously described in the prior art, in particular as concerns the homogeneity of the distribution of the nano-objects, and/or nanostructures, and/or sub-micron objects, at low contents, and concentrations.

In effect, this conservation of the state, which was that of the nano-objects, and/or nanostructures, and/or sub-micron objects in the initial dispersion, and also that of the final composite material is intimately linked to the operational use of the particular capsules according to the invention, and is, in particular, surprisingly observed, for a low concentration of nano-objects, and/or nanostructures, and/or sub-micron objects, that is, at a concentration generally lower or equal to 5% by mass, preferably lower or equal to 1% by mass, preferably from 10 ppm to 0.1% by mass in the composite material.

But the invention may also be operationally implemented in an advantageous manner for high concentrations of nano-objects, and/or nanostructures, and/or sub-micron objects, for example a concentration that may go up to and close to 20% by mass. At these high concentrations, the method according to the invention makes it possible to control the organisation, the arrangement and the level of entanglement.

In general, the concentration of nano-objects and/or sub-micron objects, and/or nanostructures, will therefore be from 10 ppm to 20% by mass, preferably from 10 ppm to 5% by mass, more preferably from 10 ppm to 1% by mass and, still better, from 10 ppm to 0.1% by mass in the final composite material.

Because of the homogeneous distribution of the nano-objects, nanostructures obtained according to the invention at a low content, at a low concentration, that is, generally equal to or less than 5% by mass, preferably equal to or less than 1% by mass, the improvement of certain properties (mechanical, electric, thermal, magnetic, etc due to these nano-objects, and/or nanostructures, and/or sub-micron objects, such as carbon nanotubes, is observed at lower concentrations. Thus it is possible to achieve substantial savings in terms of materials which are often costly on the one hand, and whose processes of synthesis are not suited to mass-production, on the other hand.

The shape, and the properties of the nano-objects and/or sub-micron objects, and/or nanostructures are not affected in the reinforced capsules according to the invention nor in the composite materials of the invention, they do not undergo any degradation either in the capsules or in the composite materials.

Finally, the invention relates to the use of a reinforced, gelled capsule as described here above, or of a reinforced, lyophilised, gel capsule as described here above, as a chemical microreactor in the inside of which chemical reactions are carried out, for example reactions for the chemical vapour phase deposition (CVD).

### BRIEF DESCRIPTION OF THE DRAWINGS

The invention will be better understood after reading the detailed description that follows, provided for illustrative purposes but not in any way limiting with reference made to the attached figures, in which:

FIG. 1 is a photograph, taken with a scanning electron microscope (SEM), which shows the tearing of the external membrane of lyophilised capsules at the moment of lyophilisation of these capsules according to the method described in the document WO-A1-2010/012813.

The scale shown in FIG. 1 represents 20 μm.

FIG. 2 is a photograph, taken with a scanning electron microscope (SEM), which shows the torn zones of the external membrane of lyophilised capsules prepared according to the method described in the document WO-A1-2010/012813.

The scale shown in FIG. 2 represents 1 μm.

FIG. 3 is a schematic cross-sectional view of a reinforced, lyophilised capsule, according to the invention, with an external carbonate shell, for example made of CaCO₃.

FIG. 4 is a photograph, taken with a scanning electron microscope (SEM), which shows the external shell made of CaCO₃ of a reinforced lyophilised capsules according to the invention.

The scale shown in FIG. 4 represents 200 μm.

FIG. 5A is a photograph, taken with a scanning electron microscope (SEM), of a reinforced lyophilised capsule according to the invention with its external shell made of CaCO₃.

The scale shown in FIG. 5A represents 200 μm.

FIG. 5B is a photograph, taken with a scanning electron microscope (SEM), which shows the surface of the external shell made of CaCO₃ of the lyophilised capsule shown in FIG. 5B.

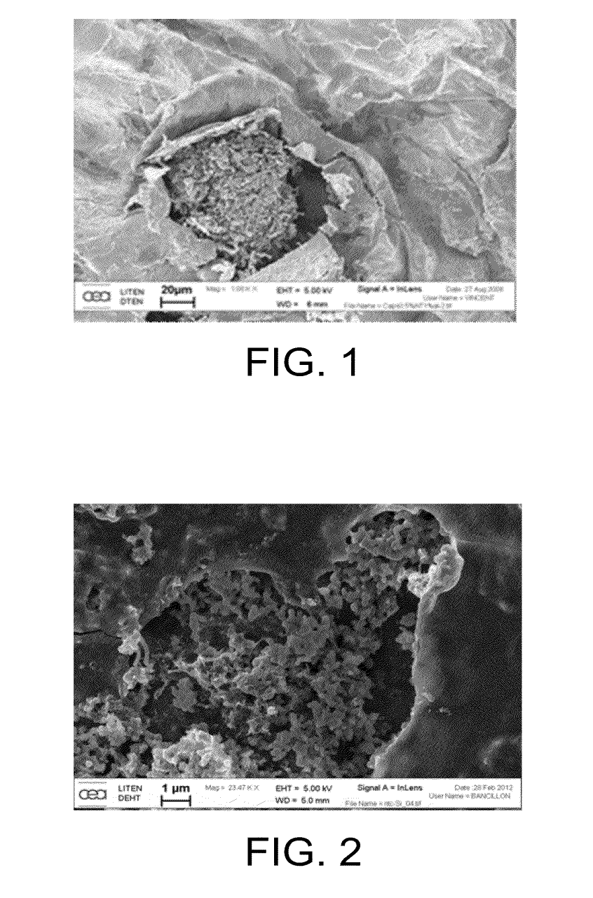

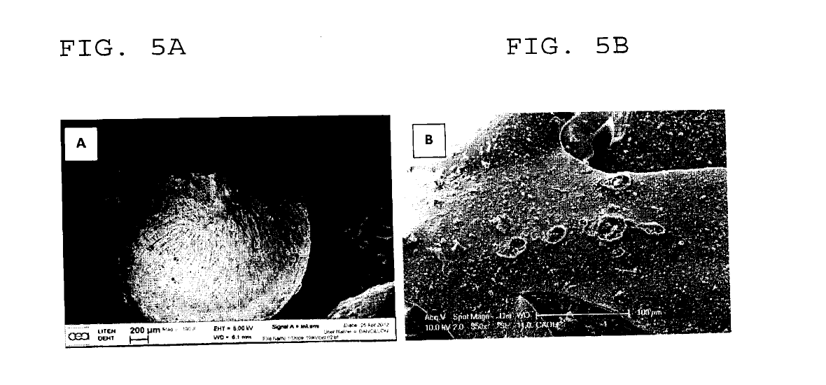

The scale shown in FIG. 5B represents 100 μm.

### DETAILED DESCRIPTION

The detailed description that follows has been developed in connection with the method of preparation according to the invention for preparing “gelled” capsules, lyophilised capsules, and nanocomposite materials having a polymer matrix, but it also contains information that applies directly to the capsules and materials according to the invention.

As a preamble to this detailed description, it is first of all necessary to set out the definition of certain of the terms used in the present document.

The term nano-objects, is generally used to refer to any single object or object linked to a nanostructure and of which at least one of the dimensions is less than or equal to 500 nm, preferably less than or equal to 300 nm, more preferably less than or equal to 200 nm, better yet less than or equal to 100 nm, for example in the range from 1 to 500 nm, preferably from 1 to 300 nm, more preferably from 1 to 200 nm, better yet from 1 to 100 nm; still better yet from 2 to 100 nm, or even from 5 to 100 nm.

These nano-objects can be, for example, nanoparticles, nanowires, nanofibres, nanocrystals or nanotubes.

The term sub-micron object, is generally used to refer to any object whose size, such as the diameter in the case of a spherical or spheroidal object, is less than 1 urn, preferably from 50 to 800 nm.

The term nanostructure, is generally used to refer to an architecture built from an assembly of nano-objects and/or sub-micron objects which are organised with a functional logic and which are structured within a space going from one cubic nanometre to one cubic micrometre.

The term polysaccharide, is generally used to refer to a polymeric organic macromolecule made up of a chain of monosaccharide units. Such a macromolecule can be represented by the chemical formula —[Cₓ(H₂O)_{y}]ₙ—.

The term capsule (or agglomerate), is generally used to refer to a system, comprising, preferably a composite, constituted of a solvent, preferably a solvent comprising mostly of water; or only constituted of water; nano-objects and/or sub-micron objects, and/or nanostructures; macromolecules of polysaccharide(s); and positive ions acting as cross-linking nodes between two polysaccharide molecules.

The term metamaterials, in physics, in the field of electromagnetism, is generally used to refer to all of those artificial, composite and nanocomposite materials that have electromagnetic properties which are not found in naturally occurring materials.

Nanocomposite materials having a polymer matrix have already been defined above.

In a first step, the process involves dispersing in the first solvent, generally containing mostly water, the nano-objects and/or sub-micron objects, and/or nanostructures, and into this first solution gets added so as to be dissolved, at least one macromolecule belonging to the family of polysaccharides, through which process is obtained a first solution or dispersion in which the nano-objects and/or sub-micron objects, and/or nanostructures are dispersed.

At this stage of the method, one may add to the first solution a polymer or a monomer that is soluble in the first solvent, for example water-soluble, whose function will be to maintain the gelled structure when the first solvent, such as water, will be gone.

The term “solvent containing mostly water”, is generally used to indicate that the solvent contains 50% or more by volume of water, preferably 70% or more by volume of water, more preferably 99% or more by volume of water, for example 100% of water.

As well as water in the proportions mentioned above, the first solvent may contain at least one other solvent, generally chosen from the alcohols, in particular the aliphatic alcohols such as ethanol; polar solvents, in particular ketones such as acetone; and mixtures thereof.

In addition to the above-mentioned solvents, the first solution, as has already been noted above, may also contain at least one polymer chosen from the polymers that are soluble in the first solvent, for example water-soluble polymers such as the polyethylene glycols (PEGs), the poly(oxides of ethylenes), the poly(acrylamides), the poly(vinyl pyridines), the (meth)acrylic polymers, the celluloses, the chitosans, the PVAs (polyvinyl alcohols), whose function is to stabilise in an efficient manner the dispersion of nano-objects and/or sub-micron objects, and/or nanostructures.

The nanostructures may be constructions or assemblies whose bricks are the nano-objects and/or the sub-micron objects.

Nanostructures may, for example, be carbon nanotubes “decorated” with nanoparticles of platinum, copper or gold; silicon nanowires “decorated” with gold, nickel, platinum, etc.

Amongst the nanostructures, mention may also be made, in particular, of the nanostructure ZnO—Ni which is a three-dimensional structure of ZnO terminated with nanospheres of nickel.

The capsules may contain only one single type of nano-object, sub-micron object, or nanostructure, but it may at the same time contain numerous types of nano-objects and/or sub-micron objects, and/or nanostructures, which may differ in their shape and/or in their size and/or in the material of which they are constituted.

For example, a capsule may contain at the same time carbon nano-objects, such as carbon nanotubes, and nanoparticles of metal such as copper; or at the same time carbon nano-objects, such as carbon nanotubes, and nanoparticles or sub-micron particles of silicon.

There is no limitation with respect to the polysaccharide macromolecule, and all the molecules belonging to the family of polysaccharides may be used in the method according to the invention. These can be natural polysaccharides or synthetic ones.

The polysaccharide macromolecule may be chosen from the pectins, the alginates, alginic acid, and the carragheenans.

The term “alginates”, is used to refer to both alginic acid and the salts and the derivatives thereof, such as sodium alginate. The alginates and, in particular, sodium alginate are extracted from various brown algae Phaeophyceae, mainly the Laminaria such as Laminaria hyperborea; and the Macrocystis such as Macrocystis pyrifera. Sodium alginate is the most commonly marketed form of alginic acid.

Alginic acid is a natural polymer with the basic formula (C₆H₇NaO₆)n made up of two monosaccharide units: D-mannuronic acid (M) and L-guluronic acid (G). The number of basic alginate units is generally around 200. The proportions of mannuronic acid and guluronic acid vary from one species of algae to another, and the ratio of number of M units to G units can range from 0.5 to 1.5, preferably from 1 to 1.5.

Alginates are linear, unbranched polymers and are not generally random copolymers but, depending on the algae from which they come, they are made up of similar or alternate sequences, that is to say GGGGGGGG, MMMMMMMM, or GMGMGMGM sequences.

For example, the ratio M/G of the alginate derived from Macrocystis pyrifera is around 1.6 whereas the ratio M/G of the alginate derived from Laminaria hyperborea is around 0.45.

Amongst the polysaccharide alginates derived from Laminaria hyperborea, mention may be made of Satialgine SG 500, amongst the polysaccharide alginates derived from Macrocystiis pyrifera with different molecule lengths, mention may be made of the polysaccharides known as A7128, A2033 and A2158 that are generics of alginic acids.

The polysaccharide molecule used in the invention generally has a molecular mass of 80000 g/mol to 500000 g/mol, preferably from 80000 g/mol to 450000 g/mol.

The dispersion of the nano-objects and/or sub-micron objects, and/or nanostructures in the first solvent and bringing about dissolution of the polysaccharides may be two simultaneous operations, or they may indeed be two consecutive operations, the dispersion preceding the process of bringing about dissolution, or vice versa.

The dispersion of the nano-objects, such as nanotubes, and/or sub-micron objects, and/or nanostructures, in the first solvent can be carried out by adding the nano-objects and/or sub-micron objects, and/or nanostructures to the first solvent and then subjecting the solvent to the action of ultrasound with an acoustic power density generally from 1 to 1000 W/cm², for example from 90 W/cm², for a time period of, generally, from 5 minutes to 24 hours, for example 2 hours.

Bringing about dissolution of the polysaccharide(s) may be carried out by the simple addition to the first solvent and under stirring conditions, generally at a temperature of from 25° C. to 80° C., for example 50° C., for a period generally of 5 minutes to 24 hours, for example two hours.

The content of nano-objects and/or sub-micron objects, and/or nanostructures, and the content level of polysaccharide(s) depend on the quantity of nano-objects and/or sub-micron objects, and/or nanostructures to be coated, in relation to the quantity of molecules of polysaccharides.

The content of nano-objects and/or sub-micron objects, and/or nanostructures in the first capsule, or gelled capsule, as well as the content of polysaccharides, are generally less than or equal to 5% by mass, preferably less than or equal to 1% by mass, of the mass of the solvent. The invention makes it possible to obtain particularly advantageous effects at these “weak” concentrations. More preferably, the content of nano-objects and/or sub-micron objects, and/or nanostructures and the content of polysaccharides are from 10 ppm to 5% by mass, more preferably from 10 ppm to 1% by mass, and better yet from 10 ppm to 0.1% by mass of the mass of the solvent in the gelled capsule.

The ratio of the number, or quantity, of macromolecules to the number of nano-objects and/or sub-micron objects, and/or nanostructures in the first solution and, by way of consequence, in the gelled capsules or agglomerates and then in the reinforced capsules (there is no modification of the ratio following as a result of the formation of the hydroxide shell, the ratio remains the same) is generally from 0.1 to 10, preferably equal to or close to 1.

This ratio between the quantity, the number of macromolecules of polysaccharides and the quantity, or number of nano-objects and/or sub-micron objects, and/or nanostructures, establishes the level of dispersion, or factor of dispersion and the mean distance for the nanoparticles, or set the unit cell for the lattice of nanostructures, nanowires and nanotubes.

The optimum of the mixture will always be when the ratio of polysaccharide/nano-objects and/or sub-micron objects, and/or nanostructures (for example nanotubes) is close to 1. It is the concentrations of the species which determine the dimensions of the unit cell.

In one embodiment in which operational use is made of both nano-objects made of a first material, for example nano-objects made of carbon such as NTCs, and also nano-objects made of a second non-carbon material such as silicon nanoparticles, the first step of the process may be carried out advantageously in accordance with the following successive steps:
The nano-objects of at least one first material are placed in contact with the water, then the nano-objects of at least one first material are mixed with the water by using a succession of techniques which may possibly be repeated, these being a technique of mixing by ultrasound, then followed by a technique of high-speed mixing, the mixture of nano-objects of at least one first material and water being kept in circulatory motion, for example by a pump such as a peristaltic pump, in a manner so as to prevent the nano-objects of a first material from agglomerating, through which process is obtained a dispersion made up of nano-objects of at least one first material and water that is kept in circulation.

In effect, this dispersion is an unstable mixture upon stopping of the circulatory motion, for example upon stopping of the pump, such as a peristaltic pump that moves the mixture of nano-objects and water from the apparatus used for carrying out the technique of ultrasound mixing, such as an ultrasound mixer, disperser, to the apparatus used for carrying out the high-speed mixing;
Without interrupting the circulatory motion of the dispersion, the ultrasound mixing is stopped, and the nano-objects or the sub-micron objects of at least one second material are mixed with the dispersion made up of the nano-objects of at least one first material and the water, by using a technique of high-speed mixing, through which process is obtained a dispersion made up of nano-objects of at least one first material, nano-objects or sub-micron objects of at least one second material and water that is kept in circulation;
Without interrupting the circulatory motion of the dispersion, the process involves adding, at constant speed, and progressively dissolving, at least one polysaccharide in the dispersion made up of the nano-objects of at least one first material, of nano-objects or sub-micron objects of at least one second material, and water and the macromolecules are mixed with the dispersion by using a high-speed mixing technique, through which process is obtained a dispersion in which are distributed in a homogeneous manner the nanostructures, each made up of a three-dimensional array made up of nano-objects of at least one first material, bonded and held by a hydrogel of the polysaccharide, the nano-objects or sub-micron objects of at least one second material being auto-assembled around the said array and being attached to the nano-objects of at least one first material by the said hydrogel of the polysaccharide.

The very specific structure, or organisation, of the material thus obtained can be defined as a structure, or organization like a “bunch of grapes” in which the nano-objects of a first material, such as carbon, for example carbon nanotubes form a three-dimensional array, or skeleton, around which come to be agglomerated, aggregated, self-assembled, the nano-objects of a second material, for example of a material other than carbon, such as silicon nanoparticles.

The nano-objects of a first material, for example nano-objects of carbon such as NTCs make up the branch and the stalks of the bunch of grapes, while the nano-objects of a second material, for example of a second material other than carbon (in the event where the first material is carbon), such as silicon nanoparticles make up the grapes.

In a second step, gelled capsules (first capsules or agglomerates) are prepared by putting the first solution or dispersion of nano-objects and/or sub-micron objects, and/or nanostructures, prepared during the first step, described herein above, in contact with a second solution, known as a gelling or cross-linking solution.

This second solution is a solution in a second solvent, comprising a majority of water, and comprising at least one salt of an element that is soluble in water, capable of releasing into the second solution cations of the said element, the concentration of the said element in the second solution being such that it is higher than the concentration of the said element which corresponds to the solubility limit of the hydroxide of the said element in the said second solution.

This salt is not a hydroxide of the said element.

The said cations are generally chosen from the monovalent-, divalent-, and trivalent cations.

The term “solvent comprising a majority of water”, is generally used to indicate that the solvent of the second solution contains 50% or more by volume of water, preferably 70% or more by volume of water, and more preferably more than 99% by volume of water, for example 100% of water.

The solvent may comprise, in addition to water in the proportions mentioned above, and when it does not comprise 100% water, at least one other solvent compound chosen generally from the alcohols, in particular the aliphatic alcohols such as ethanol; polar solvents, such as ketones for example acetone; and mixtures thereof.

The divalent cations may be chosen from Cd²⁺, Cu²⁺, Ca²⁺, Co²⁺, Mn²⁺, Fe²⁺, and Hg²⁺.

The monovalent cations may be chosen from Li⁺, Na⁺, K⁺, Rb⁺, Cs⁺, Ag⁺, Ti⁺, and Au⁺.

The trivalent cations may be chosen from Fe³⁺, and Al³⁺.

The anion of the salt(s) may be chosen from nitrate, sulfate, phosphate, and halides ions such as chloride, bromide.

The solution may comprise only one salt, or indeed it may comprise a plurality of salts.

Advantageously, the solution comprises a plurality of salts so that a mixture of cations can be released into the second solution.

The solution may contain a mixture of salts which can release into the solution a mixture of cations including at least one monovalent cation, at least one divalent cation and at least one trivalent cation.

A mixture of cations chosen from the three families of monovalent, divalent, and trivalent cations and comprising preferably at least one cation chosen from each of the families, makes it possible to control the quantity of cross-linking nodes of the system, and makes it possible in particular to bring this quantity of cross-linking nodes to a minimum in order to thereby ensure the structural stability of the gelled capsules and then of the lyophilised capsules.

In effect, the quantity of cross-linking nodes is a parameter that it is necessary to control, depending on the use that is to be made of the capsules and their applications.

Preferably, however, the second solution contains only one salt that is a calcium salt such as CaCl₂. The concentration of calcium may, for example, be maintained at a higher level, or even at a much higher level than 1.3 10⁻² mol/L, preferably it is from 2 to 20 10⁻² mol/L, for example 9 10⁻² mol/L.

The minimum value of 1.3 10⁻² mol/L corresponds to the solubility limit of the calcium hydroxide Ca(OH)₂.

The bringing into contact of the first solution and the second solution is generally carried out under the following conditions:

In a first embodiment of the bringing about of contact, the solution of dispersed nano-objects and/or sub-micron objects, and/or nanostructures falls drop by drop into the second solution. In this case, the size of the nozzle is important as it determines the size of the gelled capsule. If it is too large, the subsequent lyophilisation, extraction of, for example, water, does not take place as well, and there is greater shrinking and therefore the dispersion is not as good.

If the nozzle is too small, the capsules lyophilise perfectly, but the time for preparation of these gelled agglomerates is incredibly long. The optimum size for the nozzle is between 0.5 and 2 mm, ideally 1 mm.

Depending on the conditions of bringing about of contact and the nature of the nano-objects and/or sub-micron objects, and/or nanostructures, it is possible to produce either spherical gel capsules or else gelled agglomerates that are filamentary and stretched with controlled stretching ratios.

In a second embodiment of this bringing about of contact, and instead of using the drop by drop technique, continual bringing about of contact is achieved by placing the nozzle directly in the cross-linking solution.

The shape and size of the nozzle and, in particular, the ratio between the diameter of the entry cylinder and the diameter of the exit cylinder, and the length of the latter determine the stretching ratio of the nano-objects and/or sub-micron objects, and/or nanostructures such as the carbon nanotubes.

By way of example, an entry diameter and exit diameter, respectively, of 2 mm and 50 μm produce a stretching ratio of 400%. By doubling the entry diameter for the same exit diameter, the stretching ratio is multiplied by 4 so as to reach 1600%.

This type of stretching makes it possible if required, to align the nano-objects and/or sub-micron objects, and/or nanostructures such as carbon nanotubes. If this nozzle is equipped with electrodes to generate an electric field, this allows for organising the nano-objects and/or sub-micron objects, and/or nanostructures just prior to the gelling.

The spherical gelled capsules may have a size of from 100 μm to 5 mm and the filamentary gelled capsules may have a size of from 10 μm to 5 mm.

As a consequence, it is possible to control the orientation of the nano-objects and/or sub-micron objects, and/or nanostructures in the gelled agglomerates, which are aligned in the case of maximum stretching, or else which are oriented in a purely random manner but regularly distributed, in a homogeneous manner in the case of spherical capsules.

Generally, the capsules formed are kept in the cross-linking solution during the time period necessary for the gelling of the capsules to be complete and “to the core”. This time period is generally from 0.5 hour to 8 hours, for example one hour.

It is also possible to form only one cross-linked skin and to maintain the interior of the primary capsules in the liquid state. This can be achieved by projecting by a spray the cross-linking solution on the liquid drop as it forms and before it leaves the nozzle. It is thus possible to maintain a large mobility of the nano-objects and/or sub-micron objects, and/or nanostructures nano-objects and/or sub-micron objects, and/or nanostructures within the interior of the capsules.

In certain fields, it is necessary to have high-performance metamaterials, maintaining high values of electric or magnetic permittivity at very high frequencies. The mobility of charge carriers thus remains maximal even at high frequencies, which is not the case in solid metamaterials. Maintaining this mobility is an significant advantage.

The second step can be reversible. The beneficial interest of the reversible character of this step is, in particular, that in the case of partially gelled capsules used as chemical minireactors, it can be of interest to recover the reaction products by “degelling” the skin of the reactor in order to thus be able to recover the novel nanostructure that has been formed. Thus, the first capsules, or agglomerates can be destroyed, or dismantled, by putting them in contact with chelating agents, chelators.

These chelating agents are the chelating agents specific to the cations included in the structure of the capsules.

Thus, diethylene tetramine pentaacetic acid (DTPA) or ethylene diamine tetraacetic acid can be chosen for Ca²⁺ cations, or trientine (Triethylene tetramine, TETA) for Fe³⁺ and Al³⁺ cations.

In a third step, the first capsules, or gelled capsules, obtained at the end of the second step, are separated, taken out of the second solution, or cross-linking solution by any appropriate separation process, for example by filtration, and they are rinsed in deionized water to eliminate the ions coming from the salt of the second cross-linking solution, for example the Ca²⁺ ions and the Cl⁻ ions, from the surface of the capsules.

The gelled capsules, such as the spheres obtained during the second step and then separated, can possibly be treated by impregnation, for example with polyethylene glycol or any other water-soluble polymer or monomer, in solution (as an example, with water the optimal concentration of polyethylene glycol is 20%). Examples of such polymers have already been given above.

The separated and rinsed gelled capsules are then immersed in a hydroxide solution of the same element as that of the salt of the second solution.

Generally, the gelled capsules are immersed in the hydroxide solution directly after rinsing, without waiting for them to dry.

Preferably, this hydroxide is the calcium hydroxide Ca(OH)₂. The concentration of hydroxide of said element in said solution is higher than the solubility limit of said hydroxide.

Preferably, the concentration of hydroxide of said element in said solution is slightly higher than the solubility limit of said hydroxide. The term “slightly higher”, is generally used to indicate that this concentration is at least 20% higher than the solubility limit of the hydroxide in said solution.

The concentration of the element within the interior of the capsule is higher than the concentration of the element in the hydroxide solution, whereby the reinforced capsule in which the external surface of the capsule is covered by crystals of the hydroxide of said element is obtained.

It should be noted that in order for the concentration of the element within the interior of the capsule to be higher than the concentration of the element in the hydroxide solution, a cross-linking solution may be used whose concentration of an element such as Ca is significantly higher than that of the hydroxide solution, for example at least twice as high.

In effect, as the concentration of the element such as calcium within the interior of the capsule is higher than the concentration of the element in the hydroxide solution, for example in the calcium hydroxide solution, the cations, such as the Ca²⁺ cations, thus diffuse across the membrane of polysaccharide, for example of gelled alginate. The gelled membrane has the property of being selectively permeable to cations, it thus only lets cations pass through. When the cations, for example Ca²⁺ cations, have passed through the membrane, they come into contact with the hydroxide solution, and there is nucleation of a hydroxide precipitate, for example of Ca(OH)₂.

This process generally goes on for a period of 5 to 60 minutes, for example for 15 minutes, and the surface of the capsules is covered with crystals of hydroxide, for example of Ca(OH)₂.

These crystals generally take the form of discrete island like blocks, sheets (as described above), on the surface.

These gelled capsules covered with hydroxide crystals are the reinforced gelled capsules, according to the invention.

The reinforced gelled capsules are separated, removed from the hydroxide solution by any appropriate separation process, for example by filtration.

These reinforced, gelled capsules are frozen, for example by being immersed in liquid nitrogen. The instantaneous solidification minimises the discharge of the solvent, such as water, from the capsules and maintains maximum dispersion. This solidification, freezing, constitutes in fact the first part of the lyophilisation treatment. The frozen capsules may possibly be stored for some time in a deep-freezer before carrying out the sublimation process and the subsequent treatments.

This solidification, deep-freezing of the capsules, possibly impregnated, is followed by a sublimation step which constitutes the second part of the lyophilisation treatment. During the course of this sublimation step, under the effect of a vacuum, the frozen solvent, such as ice, is eliminated from the inside of the capsules, and possibly the polymer, such as polyethylene glycol, is crystallised.

The capsules may thus be placed, for example, in a chamber cooled to at least −20° C. and under a high vacuum (10⁻³-10⁻⁷ mbar) in order to sublimate the frozen solvent such as ice and, possibly, to crystallise the polymer present such as polyethylene glycol.

The lyophilisation treatment may possibly also include a third part, during which the agglomerates are cold-dried.

Lyophilisation may be carried out whatever the solvent of the gelled capsules, whether it be water or any other solvent or mixture of solvents. Generally, however, it is necessary that the solvent of the gelled capsules contain a majority of water or even be constituted only of water.

Following the lyophilisation, there remains practically no solvent in the lyophilised capsules. The content level of solvent is generally less than 0.01% by mass.

If the solvent of the gelled agglomerates is constituted of water, the water content in the lyophilised capsules is generally less than 0.01% by mass.

The reinforced gelled capsules maintain their shape and, generally, 90% of their volume after lyophilisation.

The organisation of the nano-objects, such as CNTs, is maintained in the lyophilised capsules.

Possibly, in order to eliminate at least part of the polysaccharide from the lyophilised capsules, the lyophilised capsules are subjected to a thermal or enzyme treatment.

The thermal treatment has generally to be carried out at a sufficiently high temperature and for a time period long enough to eliminate, at least partially, the polysaccharide, such as alginate.

It can also be carried out at a temperature of from 400 to 600° C., preferably from 500 to 550° C. for a period of 1 to 5 hours, preferably from 1 to 3 hours, more preferably from 1 to 2 hours.

For example, the temperature could be raised slowly, at the rate of 1° C./minute from ambient temperature to 500° C., be maintained at 500° C. for a period of 1 hour, and then lowered again at the rate of 1° C./minute from 500° C. back to ambient temperature.

The conditions for enzyme treatment can be easily determined by the man skilled in the art. Examples of these conditions have already been given here above.

The lyophilised capsules are then exposed to a gas containing carbon dioxide, whereby the crystals of an hydroxide of an element that covers the external surface of the capsule are transformed into a layer of carbonate of said element.

Said layer generally has a thickness of from 10 μm to 100 μm.

For example, the crystals of calcium hydroxide may be transformed into crystals of calcium carbonate.

The gas containing carbon dioxide generally contains from 1% to 100% of carbon dioxide and can be, simply, air.

The time period of exposure of the capsules to the gas containing carbon dioxide, such as air, is generally from 2 to 48 hours, for example 24 hours.

The hardening of the shell occurs according to the following chemical reaction in the case of calcium hydroxide:

Ca(OH)₂+CO₂→CaCO₃+H₂O

The reaction of the Ca(OH)₂ with the CO₂ in the air produces water which locally dissolves the crystals of Ca(OH)₂, in order to finally form, after hardening, a continuous shell made of CaCO₃.

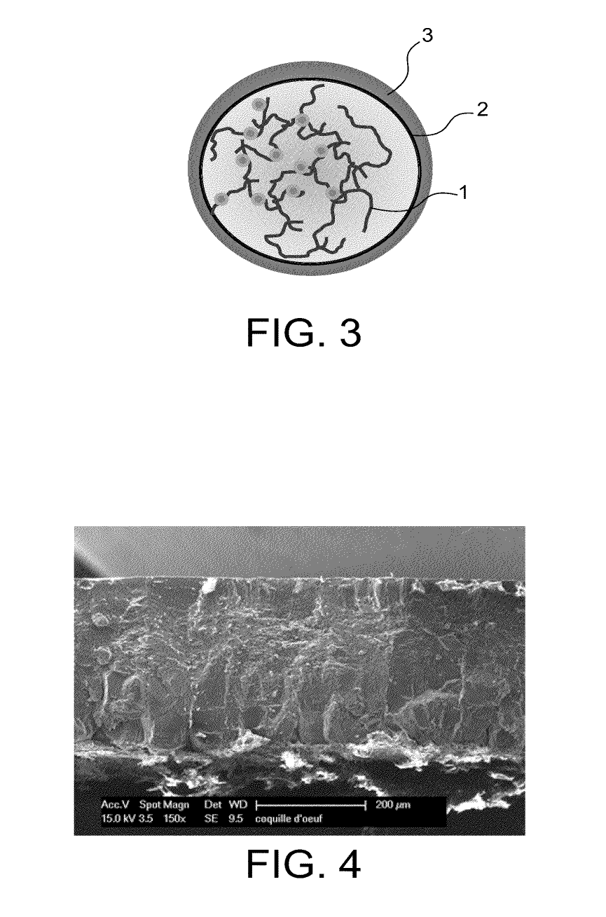

In FIG. 3, is represented a reinforced, lyophilised, gelled capsule, according to the invention with, as an example, nanostructures of NTC and nanoparticles of silicon (1) within the interior of the capsule, a membrane of polysaccharide (2), for example alginate, and a shell of carbonate (3), for example CaCO₃.

In fact, the shell of carbonate such as CaCO₃, comprises of a stack or a “mille-feuilles (multi layered cake)” consisting of an alternance of layers of carbonate having a thickness of 1 nm to 10 nm, and layers of polysaccharide having a thickness of 50 nm to 100 nm.

The total number of layer is from 10 to 100 and the top layer of the stack is a layer of polysaccharide.

The total thickness of the carbonate shell is from 10 μm to 500 μm.

The reinforced gelled capsules, or the capsules that have been lyophilised, and possibly subjected to thermal or enzyme treatment, and reinforced, may then be mixed directly, by simple mechanical action, with the pellets of polymers or composites, that is to say with the mixtures of polymers and inorganic fillers such as glass fibres, particles of talc, or of mica and other materials conventionally used in the field of composites.

This mechanical action may involve one or more operations. For example, an extrusion alone may be carried out; or else a simple mechanical mixing may be carried out, possibly followed by drying of the mixture, followed by extrusion of the mixture in an extruder.

The organisation of the nano-objects and/or sub-micron objects, and/or nanostructures, such as CNTs, is maintained after mixing of the capsules with a polymer such as PMMA.

The invention will now be described with reference to the following example, the example being illustrative, and not limiting:

### Example

In this example, according to the invention, the preparation of reinforced, gelled capsules containing both carbon nanotubes and silicon nanoparticles, and the lyophilisation of these reinforced, gelled capsules in order to obtain reinforced, lyophilised, gelled capsules, is described.

The manufacture of the gelled capsule can be carried out, for example, by following the procedure described in the Patent Application FR-A1-2934600 or in the patent application WO-A1-2010/012813 to the description of which reference may be made.

Preferably, the following successive steps are carried out:
The carbon nanotubes are brought into contact with water, and then the carbon nanotubes are mixed with water, by using the succession, optionally repeated of a technique of mixing by ultrasound, then of a technique of high-speed mixing, the mixture of carbon monotubes and water being kept in circulation, for example by a pump such as a peristaltic pump, in a manner so as to prevent the carbon nanotubes from agglomerating, whereby a dispersion consisting of carbon monotubes and water that is kept in circulation, is obtained.

In effect, this dispersion is an unstable mixture upon stopping of the circulatory motion, for example upon stopping of the pump, such as a peristaltic pump that moves the mixture of carbon monotubes and water from the apparatus used for carrying out the technique of ultrasound mixing, such as an ultrasound mixer, disperser, to the apparatus used for carrying out the high-speed mixing;
Without interrupting the circulatory motion of the dispersion, the ultrasound mixing is stopped, and the silicon nanoparticles are mixed with the dispersion consisting of the carbon nanotubes and the water, by using a technique of high-speed mixing, whereby a dispersion consisting of carbon nanotubes, silicon nanoparticles and water, that is kept in circulation, is obtained;
Without interrupting the circulation of the dispersion, at least one polysaccharide is added, at a constant speed, and progressively dissolved in the dispersion consisting of the carbon nanotubes, the silicon nanoparticles and the water, and the macromolecules are mixed with the dispersion by using a high-speed mixing technique, whereby a dispersion in which are distributed in a homogeneous manner nanostructures is obtained, each consisting of a three-dimensional network consisting of carbon nanotubes bonded and held by a hydrogel of the polysaccharide, the silicon nanoparticles being auto-assembled around said network and being attached to the carbon nanotubes by said hydrogel of the polysaccharide, is obtained.

The dispersion thus prepared drops into a solution of CaCl₂ whose concentration in calcium is maintained higher than 1.3.10⁻² mol/L., ideally maintained at 9.10⁻² mol/L.

The minimal value of 1.3.10⁻² mol/L. corresponds to the solubility limit of calcium hydroxide Ca(OH)₂ of which the solubility constant amounts to 8.10⁻⁶ mol/L. Thus are obtained the capsules which start gelling.

The capsules are maintained in a cross-linking solution of CaCl₂ during the time period necessary for the gelling to be complete and to the core.

For 1 L of solution of alginate containing the NTCs and the silicon particles, 2 L of solution of CaCl₂ are needed at a concentration of 9.10⁻² mol/L. The time period for the cross-linking is around 1 hour.

The gelled capsules have a diameter of 0.5 μm to 2 mm, ideally 1 mm.

The gelled capsules are composed of water, of alginate cross-linked by the calcium, and contain the nanostructure of carbon nanotubes and silicon nanoparticles.

The exterior of the capsule is composed solely of a layer of cross-linked alginate, organised in sheets, having a total thickness of 100 nm.

In the capsule, the concentration of alginate is 15 g/litre, that of the nanotubes is 2.5 g/L. and that of the silicon is 8.75 g/L. The concentration of calcium is 0.09 mol/L.

Subsequently a solution of Ca(OH)₂ is then prepared by mixing 2.2 g of Ca(OH)₂ in 2 L of demineralised water, which gives a concentration of 1.5.10⁻² mol/L., just above the solubility limit of calcium hydroxide.

Therefore, a few crystals of calcium hydroxide remain that are not dissolved in the solution.

The gelled capsules are removed from the cross-linking solution and rinsed in deionised DI water in order to eliminate the Ca²⁺ and Cl⁻ions from the surface of the capsules. Without waiting for the drying, the capsules are immersed directly in the calcium hydroxide solution.

As the concentration of calcium within the interior of the capsules is higher than the concentration of calcium in the calcium hydroxide solution, the Ca²⁺ cations thus diffuse through the gelled alginate membrane.

The gelled membrane has the property of being selectively permeable to cations, it only lets cations pass through.

When the Ca²⁺ cations have passed through the membrane, they come into contact with the calcium hydroxide solution, and there is nucleation of a precipitate of Ca(OH)₂. This process continues for 15 minutes and the surface of the capsules is covered by crystals of Ca(OH)₂ which form discrete island like blocks on the surface.

After 15 minutes, the capsules are removed from the calcium hydroxide solution and are immersed in liquid nitrogen so as to undergo rapid deep-freezing and in order to form micro-metric crystals of ice.

These capsules are then lyophilised.

For this purpose, they are placed in a lyophilisation container at −77° C. under vacuum conditions of 0.002 mbar.

The ice is thus sublimated at the end of the process, the lyophilisation container is kept opened to air for a period of 24 hours in order to allow the hardening of the shell in accordance with the following chemical reaction:

Ca(OH)₂+CO₂→CaCO₃+H₂O

The reaction of the Ca(OH)₂ with the CO₂ in the air produces water, which locally dissolves the crystals of Ca(OH)₂, in order to finally, after hardening, form a continuous shell of CaCO₃ (FIG. 4).

The capsules have a size of between 0.5 mm and 2 mm, ideally 1 mm.

The structure of a capsule can be decomposed into 2 parts.

The first part is the core of the capsule, consisting of a nanostructure which generally has a structure described as a so-called “bunch of grapes”. This nanostructure consists of carbon nanotubes and silicon nanoparticles (the silicon nanoparticles constitute more than 90% of the volume), bonded by the alginate.

The second part of the capsule is an external layer consisting of a composite structure comprising a multi-sheet stack of layers of cross-linked alginate and layers of calcium carbonate that represent less than 10% of the volume of the capsule (this volume percentage relates to the multi-sheet stack).

Each sheet has a thickness of between 1 nm and 10 nm (the thickness of the sheets of carbonate and the sheets of alginate is the same). Depending on the time taken for its manufacture, the external layer may consist of from 10 to 100 sheets and the total thickness of the external layer may be from 10 μm to 100 μm.

Macroscopically, the capsule according to the invention thus prepared can be represented as in FIG. 5A which is a photograph showing such a capsule with an external shell.

In FIG. 5B, which is an enlarged view of the surface of the capsule shown in FIG. 5A, the stratification of the layer of CaCO₃ produced by the organisation of the gelled alginate at the nanometric scale can be seen.

It is, in particular, the crack at the bottom of the image that shows the stratification of the CaCO₃ by the gelled alginate, and that is specific to the invention.

This stratification is characteristic of the method of preparation for preparing a reinforced, lyophilised, gelled capsule, reinforced by the CaCO₃ shell of the invention.

1. A reinforced gelled capsule comprising a solvent, wherein the solvent comprises, distributed in a homogeneous manner, nano-objects, sub-micron objects, nanostructures, or any mixture thereof, coated with macromolecules of polysaccharides, the macromolecules forming, in at least a part of the capsule, a gel by cross-linking with the cations of an element, and wherein an external surface of the capsule is covered with crystals comprising a hydroxide of the element.

2. The reinforced gelled capsule according to claim 1, wherein the gel is formed throughout the whole of the capsule.

3. The reinforced gelled capsule according to claim 1, wherein a concentration of nano-objects, sub-micron objects nanostructures, or any mixture thereof, is less than or equal to 5% by mass of the total mass of the capsule.

4. The reinforced gelled capsule according to claim 1, wherein the solvent comprises 50% or more by volume of water.

5. The reinforced gelled capsule according to claim 4, wherein the solvent of the capsule, when it does not comprise 100% of water, further comprises at least one other solvent compound, selected from the group consisting of alcohols polar solvents, ketones and mixtures thereof.

6. The reinforced gelled capsule according to claim 1, wherein the nano-objects are selected from the group consisting of nanotubes, nanowires, nanofibres, nanoparticles, nanocrystals, and the mixtures thereof; and the sub-micron objects are selected from the sub-micron particles.

7. The reinforced gelled capsule according to claim 1, wherein the materials constituting the nano-objects, nanostructures, or sub-micron objects is selected from the group consisting of carbon, sulphur, metals, metals alloys, metalloids, metalloids alloys, metal oxides, metalloid oxides, ceramics, organic polymers, and mixtures thereof.

8. The reinforced gelled capsule according to claim 1, wherein the nano-objects, sub-micron objects, nanostructures, or any mixture thereof, comprise carbon nano-objects and optionally nano-objects or sub-micron objects comprising a material other than carbon.

9. The reinforced gelled capsule according to claim 8, wherein the carbon nano-objects are selected from the group consisting of carbon nanotubes, carbon nanowires, carbon nanofibers, carbon nanoparticles, carbon nanocrystals, carbon blacks, and the mixtures thereof; and the nano-objects or sub-micron objects comprise at least one material other than non-carbon material selected from the group consisting of nanotubes, nanowires, nanofibres, nanoparticles, sub-micron particles, and nanocrystals comprising a material other than non-carbon material, and mixtures thereof.

10. The reinforced gelled capsule according to claim 1, wherein the macromolecules are selected from the group consisting of pectins, alginates, alginic acid and carragheenans.

11. The reinforced gelled capsule according to claim 1, wherein the polysaccharide macromolecule has a molecular mass of from 80,000 g/mol to 500,000 g/mol.

12. The reinforced gelled capsule according to claim 1, wherein the element is calcium.

13. A reinforced, lyophilised, gelled capsule, obtained by a process comprising lyophilizing the reinforced, gelled capsule, according to claim 1, and then exposing the lyophilized capsule to a gas comprising carbon dioxide, wherein an external surface of the capsule is covered with a layer of carbonate of the element.

14. A solid nanocomposite material having a composite or polymer matrix, comprising a reinforced gelled capsule according to claim 1, wherein the nano-objects, sub-micron objects, nanostructures, or any mixture thereof, are distributed in a homogeneous manner.

15. The nanocomposite material according to claim 14, wherein the polymer of the matrix is selected from the group consisting of aliphatic and apolar polymers, copolymers of cycloolefins, polystyrenes, polar polymers, mixtures thereof, and polymers which melt or are soluble in water, and the composite of the matrix is selected from composite materials comprising at least a polymer and an inorganic filler.

16. A method for preparing the reinforced, gelled capsule, according to claim 1, comprising, in the following order:
a) dispersing the nano-objects, the nanostructures sub-micron objects, or any mixture thereof in a first solvent comprising 50% by volume of water or more, and placing into the first solvent, macromolecules of polysaccharides and optionally, a polymer that is soluble or a salt that is soluble in the first solvent, whereby a first solution is obtained;
b) preparing a third solution by contacting the first solution with a second solution in a second solvent, comprising 50% by volume of water or more, a salt of an element soluble in water, which is capable, of releasing into the second solution, cations of the element, wherein a concentration of the element in the second solution is higher than a concentration of the element which corresponds to a solubility limit of the hydroxide of the element in the second solution whereby a gelled capsule is obtained;
c) separating the gelled capsule from the third solution and rinsing with deionised water;
d) immersing the gel capsule in a solution of a hydroxide of the element, a concentration of hydroxide of the element in the hydroxide solution being higher than a solubility limit of the hydroxide, and a concentration of the element within an interior of the capsule being higher than a concentration of the element in the hydroxide solution, whereby the reinforced, gelled capsule is obtained wherein the external surface of the capsule is covered with crystals of hydroxide of the element; and
e) removing the reinforced, gelled capsule from the hydroxide solution.

17. The method according to claim 16, wherein the dispersion of the nano-objects, nanostructures, sub-micron objects, or any mixture thereof, in the first solvent and then placing into solution of the macromolecules of polysaccharides are two simultaneous operations, or two consecutive operations, the dispersion preceding the putting into solution, or vice versa.

18. The method according to claim 16, wherein a ratio of the number of macromolecules to the number of nano-objects, sub-micron objects, nanostructures, or any mixture thereof, in the first solution is from 1 to 10.

19. The method according to claim 16, wherein a content of nano-objects, sub-micron objects, nanostructures, or any mixture thereof, and a content of macromolecules of polysaccharides are less than or equal to 5% by mass of the mass of the first solvent.

20. The method according to claim 16, wherein the cations are selected from the group consisting of monovalent cations, divalent cations and trivalent cations.

21. A method for preparing the reinforced, lyophilised, gelled capsule according to claim 13, comprising, in the following order:
a) dispersing the nano-objects, nanostructures, sub-micron objects, or any mixture thereof, in a first solvent comprising 50% by volume of water or more, and placing into the first solvent, macromolecules of polysaccharides and optionally, a polymer that is soluble or a salt that is soluble in the first solvent, whereby a first solution is obtained;
b) preparing a third solution by contacting the first solution with a second solution in a second solvent, comprising 50% by volume of water or more, a salt of an element soluble in water, which is capable, of releasing into the second solution, cations of the element, wherein a concentration of the element in the second solution is higher than a concentration of the element which corresponds to a solubility limit of the hydroxide of the element in the second solution whereby a gelled capsule is obtained;
c) separating the gelled capsule from the third solution and rinsing with deionised water;
d) immersing the gel capsule in a solution of a hydroxide of the element, a concentration of hydroxide of the element in the hydroxide solution being higher than a solubility limit of the hydroxide, and a concentration of the element within the interior of the capsule being higher than the concentration of the element in the hydroxide solution, whereby the reinforced, gelled capsule is obtained wherein the external surface of the capsule is covered with crystals of hydroxide of the element; and
e) removing the reinforced, gelled capsule from the hydroxide solution,
wherein the capsule is lyophilised, and then the capsule is exposed to a gas comprising carbon dioxide, whereby the crystals of hydroxide of the element that cover the external surface of the capsule are transformed into a layer of carbonate of the element.

22. The method for preparing a nanocomposite material according to claim 14, wherein incorporation of the reinforced, gelled capsule in a polymer or composite matrix is carried out.

23. The reinforced, gelled capsule according to claim 1, which is suitable for a chemical microreactor in the inside of which chemical reactions are carried out.
